(19) United States
(12) Patent Application Publication
(10) Pub. No.: US 2014/0374328 A1
(43) Pub. Date: Dec. 25, 2014

(54) ADSORBENT, METHOD FOR PRODUCING ADSORBENT, AND WATER TREATMENT SYSTEM

(71) Applicant: KABUSHIKI KAISHA TOSHIBA, Minato-ku (JP)

(72) Inventors: Akiko SUZUKI, Tokyo (JP); Hideyuki TSUJI, Kanagawa (JP)

(73) Assignee: KABUSHIKI KAISHA TOSHIBA, Minato-ku (JP)

(21) Appl. No.: 14/202,130

(22) Filed: Mar. 10, 2014

(30) Foreign Application Priority Data
Jun. 20, 2013 (JP) 2013-129447

(51) Int. Cl. C07F 15/06; C07F 15/04; C02F 1/28; C07F 7/18

(52) U.S. Cl. CPC C07F 15/06; C07F 7/1836; C07F 15/04; C02F 1/288
USPC 210/96.1; 556/9

(57) ABSTRACT

An adsorbent includes an inorganic porous material and a ligand provided on a surface of the inorganic porous material and having a bidentate nitrogen-containing chelating functional group. The adsorbent has an infrared absorption spectrum showing a peak derived from the ligand. The peak is observed near a wavenumber of from 1,375 cm⁻¹ to 1,400 cm⁻¹ and has a full width at half maximum of from 5 cm⁻¹ to 50 cm⁻¹.

### CROSS-REFERENCE TO RELATED APPLICATION

This application is based upon and claims the benefit of priority from Japanese Patent Application No. 2013-129447 Jun. 20, 2013; the entire contents of which are incorporated herein by reference.

### FIELD

Embodiments described herein relate generally to an adsorbent, a method for producing an adsorbent, and a water treatment system.

### BACKGROUND

Metals have been used in various industries for a long time. Since many metals are toxic, industrial waste water polluted with such metals caused various types of environmental pollution in the past. Now, such metals are removed to reach extremely low concentrations. Most of such removal techniques are coagulation and sedimentation processes, and the resulting metal sludge is subjected to landfill disposal. Among metals that are toxic when discharged into the environment, many can be valuable when recycled. Methods used to recovery metals from solutions include precipitation and separation methods, electrolytic methods, solvent extraction methods, ion exchange resin methods, chelating resin methods, etc. Chelating resin methods are often used to treat heavy metals in waste water because they can achieve extremely low concentrations after the treatment.

### BRIEF DESCRIPTION OF THE DRAWINGS

FIG. 1 is a schematic diagram of a water treatment system using an adsorbent of an embodiment;

FIG. 2 is a schematic diagram of a water treatment tank connected to piping;

FIG. 3 is a Fourier transform infrared spectroscopy spectrum of an adsorbent of an embodiment;

FIG. 4A is a graph showing the results of an adsorption test performed on the adsorbents of Example 1 and Comparative Example 1 using copper and zinc;

FIG. 4B is a graph showing the results of an adsorption test performed on the adsorbents of Example 1 and Comparative Example 1 using copper and iron;

FIG. 4C is a graph showing the results of an adsorption test performed on the adsorbents of Example 1 and Comparative Example 1 using copper and nickel;

FIG. 4D is a graph showing the results of an adsorption test performed on the adsorbents of Example 1 and Comparative Example 1 using copper and cobalt; and

FIG. 5 is a graph showing the results of an adsorption test performed on the adsorbent of Example 8.

### DETAILED DESCRIPTION

An adsorbent includes an inorganic porous material and a bidentate ligand provided on a surface of the inorganic porous material and having a bidentate chelating functional group containing nitrogen. The adsorbent has an infrared absorption spectrum showing a peak derived from the ligand. The peak is observed near a wavenumber of from 1,375 cm⁻¹ to 1,400 cm⁻¹ and has a full width at half maximum of from 5 cm⁻¹ to 50 cm⁻¹.

(Adsorbent)

In an embodiment, the adsorbent includes an inorganic porous material and a ligand provided on the surface of the inorganic porous material and having a bidentate chelating functional group containing nitrogen. The inorganic porous material is particles. Hereinafter, each component will be described in detail. The materials to be adsorbed are ions that can coordinate to the chelating moiety. In the embodiment, the adsorbent is formed by imprinting using, as a template, the same type of ion as that to be adsorbed. Such an ion is a metal ion capable of forming a chelate structure with the bidentate chelating functional group containing nitrogen. Particularly in view of selectivity, the adsorbent is preferably formed by imprinting using, as a template, a fourth-row transition metal such as Mn, Fe, Co, Ni, or Cu, or Cd, Hg, Zn, or Ag. Two or more types of metal ions may also be used as templates.

<Bidentate Chelating Functional Group Containing Nitrogen>

The compound having the bidentate chelating functional group containing nitrogen used in the embodiment may be of any type. Preferably, the compound has the ligand shown below. Examples of the compound having the functional group according to the embodiment include N-(2-aminoethyl)-3-aminopropyltrimethoxysilane, N-(2-aminoethyl)-3-aminopropyltriethoxysilane, 3-(2-aminoethylamino)propyldimethoxymethylsilane, 3-(2-aminoethylamino)propyltriethoxysilane, and N-(3-(dimethoxymethylsilyl) isobutyl)ethylenediamine.

<Ligand>

In the embodiment, the adsorbent contains a ligand having a bidentate chelating functional group containing nitrogen, and chelating functional groups containing nitrogen of two molecules form a pair containing a set of four nitrogen atoms. In such a structure, all the nitrogen atoms are adjacent to one another. In the embodiment, the ligand is not imprinted using a polymer matrix template but present on a carrier. The functional group-containing ligand preferably has an ethylenediamine structure. In the embodiment, the adsorbent has a spectral peak derived from the ligand near a wavenumber of from 1,375 cm⁻¹ to 1,400 cm⁻¹ as measured by Fourier transform infrared spectroscopy. In the embodiment, the peak of the adsorbent near a wavenumber of from 1,375 cm⁻¹ to 1,400 cm⁻¹ preferably has a narrow full width at half maximum. The full width at half maximum of the peak can be narrowed by imprinting using the same type of material as that to be adsorbed. This is considered to be because the ligand-modified structures approach the structure defined by imprinting. In some cases, the peak derived from the ligand will not fall within the range of from 1,375 cm⁻¹ to 1,400 cm⁻¹ due to peak shift or peak width. Therefore, the peak derived from the ligand is defined using the term “near.” As used herein, the term “near” means, for example, ±50 cm⁻¹ (namely, the range is from 1,325 cm⁻¹ to 1,450 cm⁻¹), which however may change as the peak shift or the peak width increases.

The peak near a wavenumber of from 1,375 cm⁻¹ to 1,400 cm⁻¹ preferably has a full width at half maximum of from 5 cm⁻¹ to 100 cm⁻¹. Within this range, selectivity can be obtained for the metal ions to be adsorbed. The full width at half maximum is more preferably from 5 cm⁻¹ to 50 cm⁻¹. The selectivity for the material to be adsorbed can be further improved when the ligand used is more suitable. In such a case, the peak near a wavenumber of from 1,375 cm⁻¹ to 1,400 cm⁻¹ has a full width at half maximum of from 5 cm⁻¹ to 15 cm⁻¹, and the ligand is, for example, 3-(2-aminoethylamino)propyldimethoxymethylsilane, 3-(2-aminoethylamino)propyltriethoxysilane, or N-(3-(dimethoxymethylsilyl)isobutyl)ethylenediamine.

When the full width at half maximum is large, the pair-forming ligand present on the surface of the carrier may lose selectivity so that it can randomly coordinate to metal ions as adsorption targets. In other words, the specificity for the metal ions to be adsorbed may be lost or reduced. Such an adsorbent is not suitable to adsorb a specific species of ions.

The adsorbent preferably contains 4 wt % to 30 wt % of the ligand in view of the balance between the adsorbing functional group and the inorganic porous material. When the content is less than 4 wt %, the amount of adsorption may be lower. When the content is more than 30 wt %, the pores of the inorganic porous material may fail to be used efficiently. The concentration of the ligand can be measured using carbon-hydrogen-nitrogen (CHN) elemental analysis or thermogravimetry (Tg).

The Fourier transform infrared spectroscopy can be performed under the following conditions. To a mortar are added 1 mg of the adsorbent and 10 mg of KBr and mixed. The mixture is compression-molded into a 3-mm-φ tablet. A 3-mm-φ tablet of only KBr is also prepared for background measurement. The tablets are subjected to Fourier transform infrared spectroscopy using an infrared spectrometer (Model No. FT/IR 4100) manufactured by JASCO Corporation. Spectra of both the sample containing the adsorbent of the embodiment and the sample of only KBr are obtained and then subjected to background correction. The resulting spectrum is used as the spectrum of the adsorbent of the embodiment. A peak near a wavenumber of from 1,375 cm⁻¹ to 1,400 cm⁻¹ is analyzed in the resulting spectrum of the adsorbent. The range is set for the peak to be identified because peak shift occurs depending on the type of the ligand. The term “near” is used also due to peak shift. When the peak shift is large, the peak derived from the ligand can be identified near a wavenumber of from 1,375 cm⁻¹ to 1,400 cm⁻¹ in the spectrum. Peak shift correction may be performed as desired.

The full width at half maximum of the peak is calculated using, as a base line, the line between both ends at the bottom of the peak near a wavenumber of from 1,375 cm⁻¹ to 1,400 cm⁻¹. In the embodiment, the adsorbent is formed by imprinting using the same type of metal ion as that to be collected. In the embodiment, the peak derived from the ligand is sharp (with a narrow full width at half maximum) near a wavenumber of from 1,375 cm⁻¹ to 1,400 cm⁻¹. The narrow full width at half maximum of the peak suggests that the ligand structures approach a specific structure. On the other hand, when the adsorbent is not formed by imprinting, the ligand structures are not restricted to the structure defined by imprinting, so that a broad peak with a wide full width at half maximum can be obtained.

In the embodiment, the bidentate chelating functional group containing nitrogen of the adsorbent contains a structure of formula (1) below, in which the R moieties, exclusive of the R₁ moiety, is more preferably H. Ri is connected to the carrier through a linker. In the embodiment, the adsorbent is formed by imprinting using, as a template, the same type of material as that to be adsorbed. It is conceivable that in this case, the adsorption site can have such a structure that four nitrogen atoms in a pair of bidentate chelating functional groups containing nitrogen exist in a spherical region with a radius of 2.0 to 2.2 Å.

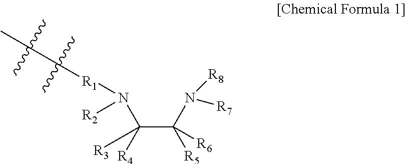

wherein R₁ is any one of CₙH₂ₙ (n is from 1 to 5), C₆H₄, and C₆H₃ (CH₃) and R₂ to R₈ are each H, CₙH₂ₙ₊₁ (n is from 1 to 5), C₆H₅, and C₆H₄ (CH₃).

Examples of the compound containing this structure include silane coupling agents. Examples of silane coupling agents that may be used in the embodiment include N-[3-(trimethoxysilyl)propyl]ethylenediamine, N-[3-(triethoxysilyl)propyl]ethylenediamine, N-(3-(dimethoxymethylsilyl)isobutyl)-ethylenediamine, and 3-(2-aminoethylamino)propyldimethoxymethylsilane. These silane coupling agents can be bonded to a carrier by silane coupling reaction, so that ligands can be introduced to the carrier.

<Inorganic Porous Material>

In the embodiment, the adsorbent includes an inorganic porous material as a carrier. The inorganic porous material may be of any type, examples of which include silica gel, zeolite, alumina, apatite, titanium oxide, etc. In particular, silica gel is preferably used as a carrier in view of large specific surface area, easiness of surface modification, and shape. In view of adsorption amount or easy handleability, these carriers preferably have an average primary particle size ranging from 30 μm to 400 μm, more preferably from 40 μm to 210 μm. The average primary particle size of the carrier can be measured by observing the adsorbent of the embodiment with a scanning electron microscope (SEM). In the embodiment, the carrier has pores, which preferably have an average pore size of from 3.0 nm to 9.0 nm in view of adsorption amount. The pore size can be measured by gas adsorption method.

<Modification Method>

Next, a description will be given of a method for modifying a carrier with a ligand of the embodiment in such a manner that a template for the material to be adsorbed can be imprinted into the carrier.

A method for producing an adsorbent of the embodiment includes the steps of: coordinating a metal ion to the chelating moiety of a silane coupling agent having a bidentate chelating functional group containing nitrogen; modifying the surface of silica gel with the silane coupling gent to which the metal ion is coordinated; and removing the coordinated metal ion from the modified silica gel.

Hereinafter, the method will be more specifically described. In the silane coupling reaction, a salt of the metal ion for serving as a template is introduced in a certain amount, so that the template ion is coordinated to the silane coupling agent. The resulting silane coupling agent is then allowed to react with the carrier, so that imprinting of the embodiment is successfully performed. More specifically, first, the silane coupling agent and the salt of the metal ion are stirred in an aqueous solution and refluxed at a temperature of 80° C. to 100° C. for about 1 hour to form a slurry. Subsequently, the carrier and a solvent such as ethanol are poured into the slurry and then stirred at a temperature of 50° C. to 90° C. for about 6 hours, so that a reaction product is obtained. The metal ion is coordinated in the reaction product. Therefore, cleaning is then performed to remove the template metal ion. The reaction product is washed twice or more with 1 N nitric acid and then washed with water and ethanol. After the washing, the reaction product is dried so that an adsorbent of the embodiment is obtained.

The silane coupling agent is preferably added in an amount of from 1.5 mole equivalents to 2.3 mole equivalents relative to the amount of the salt of the metal ion. An amount of less than 1.5 mole equivalents is not preferable in that a relatively large amount of the metal cannot form the coordination compound although the metal ion selectivity can be maintained. An amount of more than 2.3 mole equivalents is not preferable in view of selectivity for the target. The salt of the metal ion is preferably a salt that does not inhibit the silane coupling reaction. A chloride salt, a sulfate salt, a nitrate salt, or the like may be used as the salt of the metal ion.

The carrier is preferably added in an amount of from 0.1 wt % to 200 wt % based on the weight of the salt of the metal ion when the adsorbent is prepared. When the amount is less than 0.1 wt %, a relatively large amount of the silane coupling agent and the metal ion can remain unreacted, which is not preferable in view of manufacturing cost or environment. When the amount is more than 200 wt %, the carrier will be modified with a smaller amount of the adsorbing functional group, which can lead to a reduction in adsorption amount.

(Water Treatment System Using Adsorbent and Method for Using Adsorbent)

Next, a description will be given of a water treatment system using the adsorbent described above and a method for using the system. In an embodiment, a water treatment system includes an adsorption unit having an adsorbent; a supply unit configured to supply, to the adsorption unit, a metal ion-containing medium to be treated; a discharge unit configured to discharge the treated medium from the adsorption unit; a measurement unit that is provided on at least one of the supply side or the discharge side of the adsorption unit and configured to measure the content of metal ions in the medium; and a control unit that is configured to reduce the amount of the medium supply from the supply unit to the adsorption unit when a value determined based on the information from the measurement unit reaches a predetermined value.

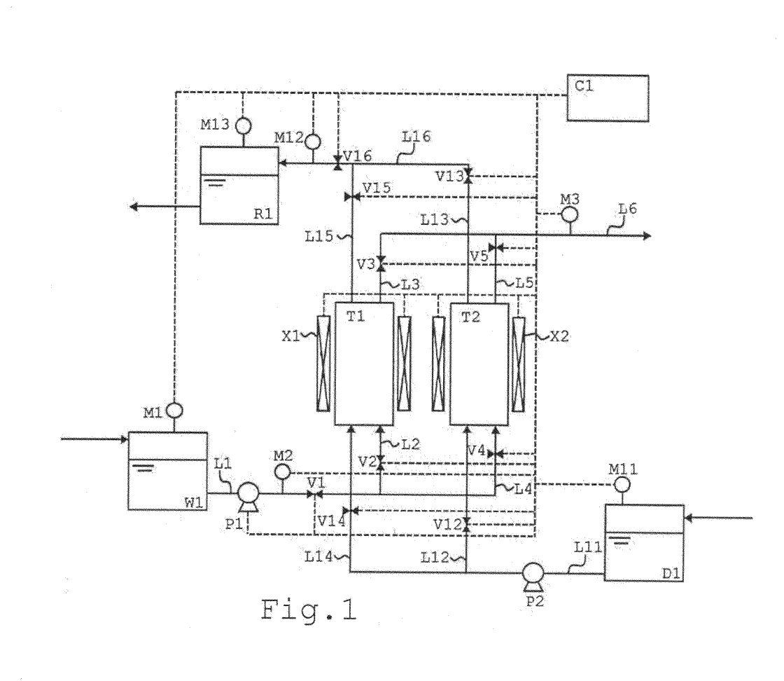

FIG. 1 is a schematic diagram showing the outline of the configuration of an apparatus for use in metal ion adsorption according to the embodiment and also shows a treatment system.

As shown in FIG. 1, the apparatus has water treatment tanks (adsorption units) T1 and T2 arranged in parallel and each charged with the adsorbent described above and also has contact efficiency-increasing units X1 and X2 provided outside the water treatment tanks T1 and T2, respectively. The contact efficiency-increasing units X1 and X2 may be mechanical stirring devices or non-contact magnetic stirrers. On the other hand, they may be omitted because they are not essential components.

The water treatment tanks T1 and T2 are connected to a waste water storage tank W1, which stores waste water (the medium to be treated) containing metal ions, thorough waste water supply lines (supply units) L1, L2, and L4, and also connected to an external unit through waste water discharge lines (discharge units) L3, L5, and L6.

The supply lines L1, L2, and L4 are provided with valves (control units) V1, V2, and V4, respectively, and the discharge lines L3 and L5 are provided with valves (control units) V3 and V5, respectively. The supply line L1 is also provided with a pump (control unit) P1. The waste water storage tank W1, the supply line L1, and the discharge line L6 are further provided with concentration measurement units (measurement units) M1, M2, and M3, respectively.

The valves, the pump, and the monitoring of the measurements in the measurement units are controlled centrally and collectively by a control unit C1.

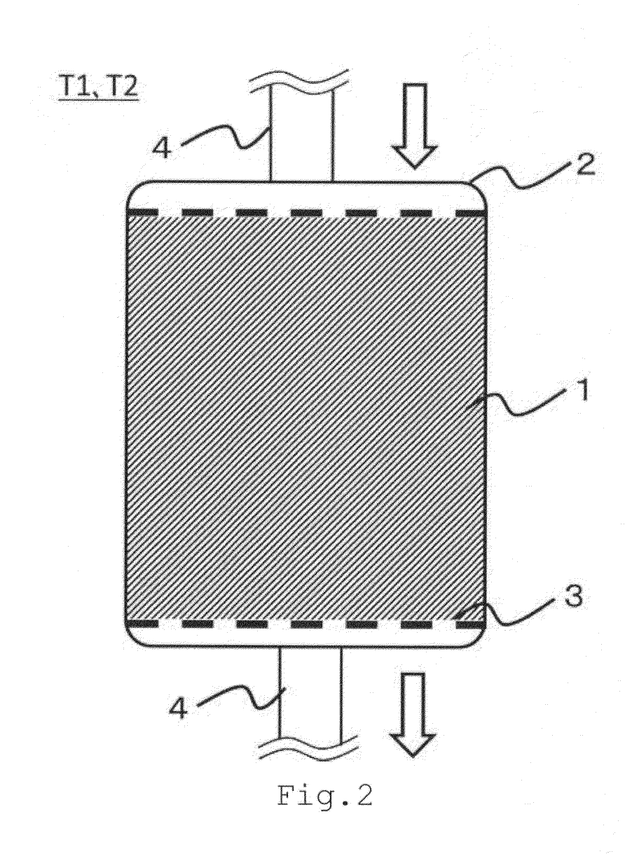

FIG. 2 is a schematic cross-sectional view showing the water treatment tanks T1 and T2 connected to piping 4 (lines L2 to L4) and charged with an adsorbent. In the drawing, the arrow indicates the direction in which the waste water (metal ion-containing medium) flows. The water treatment tanks T1 and T2 each include an adsorbent 1, a tank 2 containing the adsorbent 1 and partitions 3 configured to block the adsorbent from leaking out of the tank 2. The water treatment tanks T1 and T2 may be of a cartridge type in which the tank 2 itself is replaceable, or of another type in which the adsorbent in the tank 2 is replaceable. The tank 2 may also contain another type of adsorbent in order to adsorb and collect substances other than metal ions.

Next, a description will be given of the operation of adsorbing metal ions using the apparatus shown in FIG. 1.

First, waste water is supplied by the pump P1 from the tank W1 to the water treatment tanks T1 and T2 through the waste water supply lines L1, L2, and L4. During this process, metal ions in the waste water are adsorbed in the water treatment tanks T1 and T2, and after the adsorption, the waste water is discharged to the outside through the waste water discharge lines L3 and L5.

During this process, if necessary, the contact efficiency-increasing units X1 and X2 may be driven to increase the contact area between the waste water and the adsorbent with which the water treatment tanks T1 and T2 are discharged, so that the efficiency of the adsorption of metal ions in the water treatment tanks T1 and T2 can be increased.

During this process, the state of the adsorption in the water treatment tanks T1 and T2 is monitored by the concentration measurement units M2 and M3 provided on the supply side and the discharge side of the water treatment tanks T1 and T2. When the adsorption proceeds well, the metal ion concentration measured by the concentration measurement unit M3 is lower than the metal ion concentration measured by the concentration measurement unit M2. However, the difference between the metal ion concentrations measured by the concentration measurement units M2 and M3 on the supply side and the discharge side decreases as the amount of the adsorption of metal ions in the water treatment tanks T1 and T2 gradually increases.

Therefore, when the concentration measurement unit M3 determines that the measurement reaches a predetermined value to indicate the saturation of the metal ion adsorption capacity of the water treatment tanks T1 and T2, the control unit C1 temporarily stops the pump P1 and closes the valves V2, V3, and V4, based on the information from the concentration measurement units M2 and M3, to stop the supply of the waste water to the water treatment tanks T1 and T2.

Although not shown in FIG. 1, the concentration measurement unit M1 and/or the concentration measurement unit M2 may measure the pH of the waste water and allow the control unit C1 to control the pH of the waste water when the pH of the waste water fluctuates or when the waste water is strongly acidic or basic and has a pH out of the region suitable for the adsorbent according to the embodiment. In the embodiment, the pH suitable for the adsorption of metal ions by the adsorbent is, for example, from 2 to 9.

After the adsorption in the water treatment tanks T1 and T2 reaches saturation, they are replaced as needed by new water treatment tanks charged with a fresh adsorbent. The water treatment tanks T1 and T2 in which the adsorption reaches saturation are subjected, as needed, to a necessary post-treatment. For example, the water treatment tanks may be washed with 1 N nitric acid so that the metal ions can be extracted from the water treatment tanks.

After the adsorption of the metal ions, the adsorbed metal ions can be extracted into a solution by allowing 0.1-1 N acid to pass through the tanks or immersing the adsorbent in an acid. The acid used is preferably, but not limited to, a mineral acid such as hydrochloric acid, nitric acid, or sulfuric acid in view of cost. A chelating reagent may also be used as an extracting agent. Examples of the chelating reagent include, but are not limited to, EDTA, DTPA, and HEDP.

The embodiment described above shows a system for adsorbing metal ions in waste water using water treatment tanks and how to operate such a system. Alternatively, waste gas containing metal ions may be allowed to pass through the tanks shown above, so that metal ions in the waste gas can be adsorbed and removed.

Next, embodiments will be described in more detail with reference to examples.

### Example 1

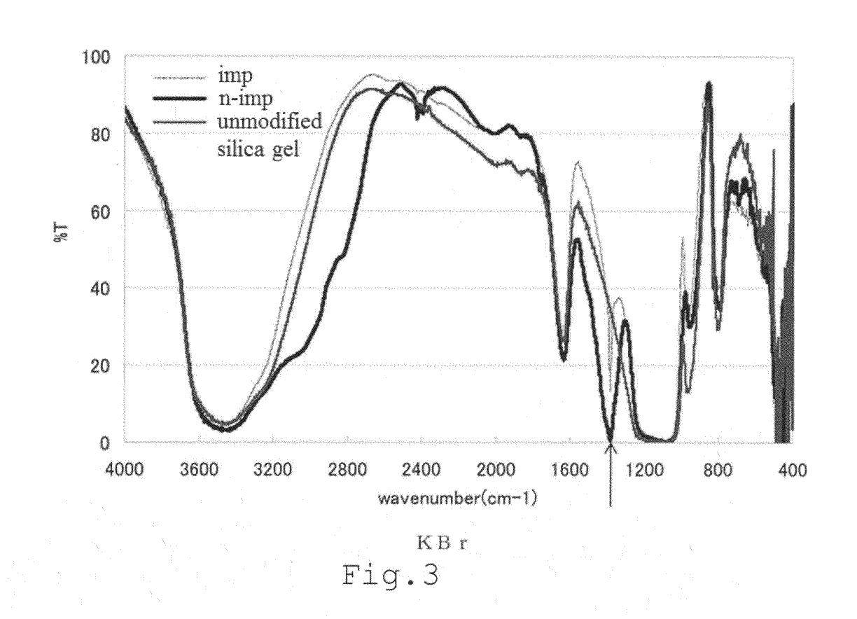

To 10 ml of water were added 0.577 g (3.38 mmol) of copper chloride dihydrate and 1.48 ml (6.77 mmol) of N-(2-aminoethyl)-3-aminopropyltrimethoxysilane. The mixture was refluxed at 100° C. for 1 hour to give a dark blue slurry. To the slurry were added 100 ml of ethanol and 2.00 g of silica gel. The mixture was stirred at 80° C. for 6 hours to give a dark blue compound. The compound was separated by filtration and then washed with 1 N nitric acid, so that its color changed to white. The compound was washed five times with 1 N nitric acid and then washed with water and ethanol. The resulting compound was dried at 60° C. to give a metal adsorbent with a white color. The resulting adsorbent was subjected to Fourier transform infrared spectroscopy using the method described above. FIG. 3 shows the results. FIG. 3 shows the IR spectra of the adsorbents of Example 1 and Comparative Example 1 and the IR spectrum of unmodified silica gel. In Example 1, the absorption peak observed near a wavenumber of from 1,375 cm⁻¹ to 1,400 cm⁻¹ had a full width at half maximum of 13.5 cm⁻¹.

The adsorbent was subjected to a performance evaluation test using the following method. For the test of adsorption selectivity, four types of test water were prepared. The four types of test water were each a solution containing 1.00 mmol of CuCl₂ (containing the template metal ion) and 1.00 mmol of one selected from NiCl₂, ZnCl₂, CoCl₂, and FeCl₃ (containing a metal ion other than the template metal ion). The test water used was also a buffer solution prepared by adding 14.8 ml of an aqueous 0.1 M acetic acid solution and 35.2 ml of an aqueous 0.1 M sodium acetate solution to a measuring cylinder and diluting the mixture with pure water to a total volume of 100 ml. Fifty mg of the adsorbent was added to 10 ml of the prepared test water. The mixture was stirred at room temperature for 24 hours with a mixing rotor and then subjected to inductively coupled plasma-atomic emission spectrometry (ICP-AES) measurement. Before the ICP-AES analysis, the test liquid was filtered through a 0.2 μm cellulose filter, and the filtrate was subjected to the measurement.

The separation factor (S.F.) was calculated from the results of the ICP-AES analysis. The S.F. was calculated from the following formula: S.F.=[M]s/[M]l*[Mn]l/[Mn]s ([M]s: the amount (mmol/g) of template metal ion adsorption at adsorption equilibrium, [M]l: the solution concentration (mmol/l) at adsorption equilibrium, [Mn]l: the concentration (mmol/l) of the non-template metal ion solution at adsorption equilibrium, [Mn]s: the amount (mmol/g) of non-template metal ion adsorption at adsorption equilibrium). The S.F. values are summarized in Table 1.

### Comparative Example 1

A metal adsorbent with a white color was obtained as in Example 1, except that copper chloride dihydrate was not used in the preparation of the adsorbent. The performance evaluation test was performed as in Example 1. In Comparative Example 1, the absorption peak observed near a wavenumber of from 1,375 cm⁻¹ to 1,400 cm⁻¹ had a full width at half maximum of 113.1 cm⁻¹.

From the spectra in FIG. 3, it has been found that only the adsorbent of Example 1 exhibits a sharp absorption peak near a wavenumber of from 1,375 cm⁻¹ to 1,400 cm⁻¹. This suggests that the structures of the modified part of Example 1 approach a specific structure.

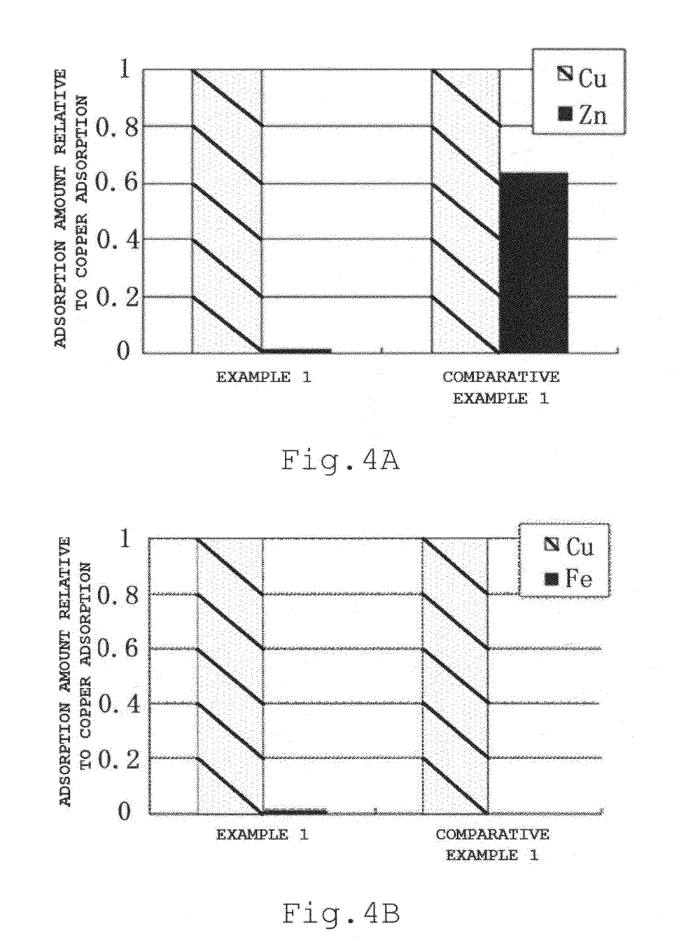

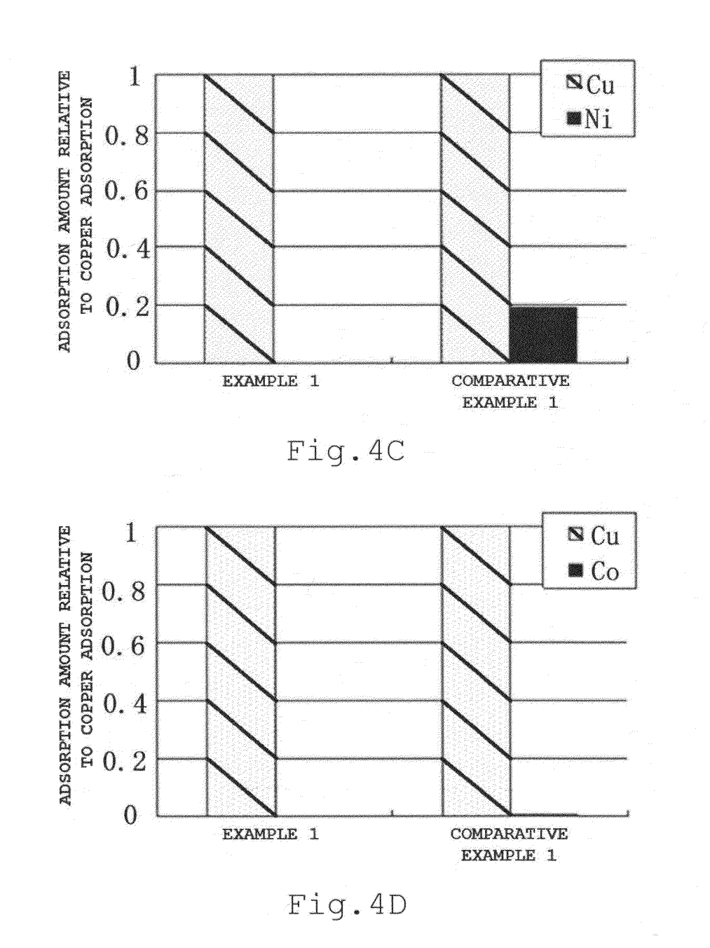

The results of the adsorption test of Example 1 and Comparative Example 1 are summarized in FIGS. 4A to 4D. FIG. 4A shows the results of the test using test water containing Cu and Zn ions. FIG. 4B shows the results of the test using test water containing Cu and Fe ions. FIG. 4C shows the results of the test using test water containing Cu and Ni ions. FIG. 4D shows the results of the test using test water containing Cu and Co ions.

It has been found that the adsorbent of Example 1 has very high selectivity for copper as compared with that of the comparative example, and hardly adsorbs the coexisting ions. The adsorbent of the comparative example also hardly adsorbs iron and cobalt ions (see FIGS. 4B and 4D). This is considered to be because of the characteristics of the adsorbing functional group itself.

### Example 2

A metal adsorbent with a white color was obtained using the same procedure as in Example 1, except that 0.803 g (3.38 mmol) of nickel chloride hexahydrate was used instead of copper chloride dihydrate. The performance evaluation test was performed as in Example 1, except that the metal salt in the test water was changed to correspond to the template metal ion. The S.F. values are shown in Table 1. In Example 2, the absorption peak observed near a wavenumber of from 1,375 cm⁻¹ to 1,400 cm⁻¹ had a full width at half maximum of 35.1 cm⁻¹.

### Example 3

A metal adsorbent with a white color was obtained using the same procedure as in Example 1, except that 0.461 g (3.38 mmol) of zinc chloride was used as the metal salt. The performance evaluation test was performed as in Example 1, except that the metal salt in the test water was changed to correspond to the template metal ion. The S.F. values are shown in Table 1. In Example 3, the absorption peak observed near a wavenumber of from 1,375 cm⁻¹ to 1,400 cm⁻¹ had a full width at half maximum of 24.1 cm⁻¹.

### Example 4

A metal adsorbent with a white color was obtained using the same procedure as in Example 1, except that 0.804 g (3.38 mmol) of cobalt chloride hexahydrate was used as the metal salt. The performance evaluation test was performed as in Example 1, except that the metal salt in the test water was changed to correspond to the template metal ion. The S.F. values are shown in Table 1. In Example 4, the absorption peak observed near a wavenumber of from 1,375 cm⁻¹ to 1,400 cm⁻¹ had a full width at half maximum of 32.9 cm⁻¹.

### Example 5

A metal adsorbent with a white color was obtained as in Example 1, except that 3-(2-aminoethylamino) propyldimethoxymethylsilane was used as the ligand. The performance evaluation test was performed as in Example 1. The S.F. values are shown in Table 1. In Example 5, the absorption peak observed near a wavenumber of from 1,375 cm⁻¹ to 1,400 cm⁻¹ had a full width at half maximum of 11.4 cm⁻¹.

### Example 6

A metal adsorbent with a white color was obtained as in Example 1, except that 3-(2-aminoethylamino)propyltriethoxysilane was used as the ligand. The performance evaluation test was performed as in Example 1. The S.F. values are shown in Table 1. In Example 6, the absorption peak observed near a wavenumber of from 1,375 cm⁻¹ to 1,400 cm⁻¹ had a full width at half maximum of 9.3 cm⁻¹.

### Example 7

A metal adsorbent with a white color was obtained as in Example 1, except that N-(3-(dimethoxymethylsilyl)isobutyl)ethylenediamine was used as the ligand. The performance evaluation test was performed as in Example 1. The S.F. values are shown in Table 1. In Example 7, the absorption peak observed near a wavenumber of from 1,375 cm⁻¹ to 1,400 cm⁻¹ had a full width at half maximum of 14.7 cm⁻¹.

### Comparative Example 2

A commercially available iminodiacetic acid-type chelating resin CR11 (manufactured by Mitsubishi Chemical Corporation) was subjected to performance evaluation. The performance evaluation test was performed as in Example 1. The S.F. values are shown in Table 1.

### Comparative Example 3

A commercially available polyamine-type chelating resin CR20 (manufactured by Mitsubishi Chemical Corporation) was subjected to performance evaluation. The performance evaluation test was performed as in Example 1. The S.F. values are shown in Table 1.

TABLE 1

| | SEPARATION FACTOR S.F. (—) | | | | |
|---|---|---|---|---|---|
| | Cu | Ni | Zn | Co | Fe |
| Example 1 | — | 857 | 433 | 2000 | 342 |
| Example 2 | 4 | — | 42 | 1092 | 2039 |
| Example 3 | 6 | 165 | — | 3129 | 3091 |
| Example 4 | 3 | 21 | 41 | — | 7351 |
| Example 5 | — | 914 | 698 | 8321 | 8732 |
| Example 6 | — | 920 | 804 | 6219 | 8549 |
| Example 7 | — | 878 | 702 | 6871 | 7093 |
| Comparative | — | 31 | 7 | 1572 | 6000 |
| Example 1 | | | | | |
| Comparative | — | 1 | 1 | 1 | 75 |
| Example 2 | | | | | |
| Comparative | — | 173 | 286 | 735 | 1168 |
| Example 3 | | | | | |

FIGS. 3 and 4A to 4D and Table 1 show that the adsorbents of the examples exhibit significantly high metal selectivity as compared with those of the comparative examples.

### Example 8

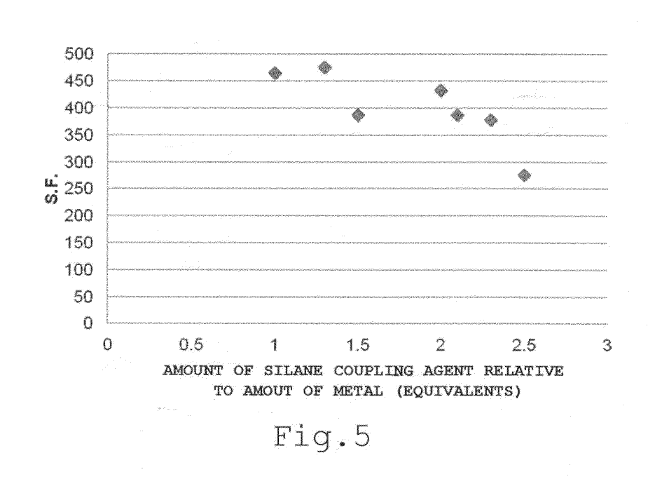

Synthesis was performed as in Example 1, except that the number of equivalents of N-(2-aminoethyl)-3-aminopropyltrimethoxysilane was varied relative to 0.577 g (3.38 mmol) of copper chloride dihydrate. The performance evaluation test was performed as in Example 1. The S.F. values with respect to zinc are summarized in FIG. 5. From FIG. 5, it has been found that the selectivity for the target significantly decreases as the amount of N-(2-aminoethyl)-3-aminopropyltrimethoxysilane becomes 2 mole equivalents or more relative to the amount of the metal ion. This is considered to be because the amount of N-(2-aminoethyl)-3-aminopropyltrimethoxysilane not forming a complex with the metal ion increases as the amount of the modification of the inorganic porous material increases. The selectivity was kept at substantially the same level in the region where the amount of N-(2-aminoethyl)-3-aminopropyltrimethoxysilane was at most 2 mole equivalents relative to the amount of the metal ion. This is considered to be because the metal ion and N-(2-aminoethyl)-3-aminopropyltrimethoxysilane in a ratio of 1:2 form a stable complex and even when the metal ion is present in an excess amount, such a complex is produced as a main product. In view of selectivity, therefore, the added amount of N-(2-aminoethyl)-3-aminopropyltrimethoxysilane should preferably be 2 mole equivalents or less.

### Example 9

A metal adsorbent with a white color was obtained as in Example 1, except that 3-(2-aminoethylamino)propyltrimethoxymethylsilane was used as the ligand. Also in Example 9, a sharp absorption peak was observed near a wavenumber of from 1,375 cm⁻¹ to 1,400 cm⁻¹.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An adsorbent, comprising:
an inorganic porous material; and
a ligand provided on a surface of the inorganic porous material and having a bidentate chelating functional group containing nitrogen,
the adsorbent having an infrared absorption spectrum showing a peak derived from the ligand, wherein the peak is observed near a wavenumber of from 1,375 cm⁻¹ to 1,400 cm⁻¹ and has a full width at half maximum of from 5 cm⁻¹ to 50 cm⁻¹.

2. The adsorbent of claim 1, wherein the ligand has an ethylenediamine structure.

3. The adsorbent of claim 1, the adsorbent containing 4 wt % to 30 wt % of the ligand.

4. The adsorbent of claim 1, wherein the inorganic porous material is particles and has an average primary particle size of from 30 μm to 400 μm.

5. The adsorbent of claim 1, wherein the inorganic porous material has an average pore size of from 3.0 nm to 9.0 nm.

6. The adsorbent of claim 1, wherein the inorganic porous material is a silica gel.

7. The adsorbent of claim 1, wherein four nitrogen atoms in a pair of the ligands exist in a spherical region with a radius of from 2.0 Å to 2.2 Å.

8. A method for producing an adsorbent, comprising:
a coordinating metal ion to a chelating moiety of a silane coupling agent having a bidentate chelating functional group containing nitrogen;
modifying a surface of a silica gel with the silane coupling agent to which the metal ion is coordinated; and
removing the coordinated metal ion from the modified silica gel.

9. The method of claim 8, wherein
the mole equivalent ratio of the silane coupling agent to the metal ion is from 1.5 to 2.3, and
the silane coupling agent and a salt of the metal ion are mixed to form a coordinate bond.

10. A water treatment system, comprising:
an adsorption unit having an adsorbent comprising an inorganic porous material and a ligand provided on a surface of the inorganic porous material and having a bidentate chelating functional group containing nitrogen, the adsorbent having an infrared absorption spectrum showing a peak derived from the ligand, wherein the peak is observed near a wavenumber of from 1,375 cm⁻¹ to 1,400 cm⁻¹ and has a full width at half maximum of from 5 cm⁻¹ to 50 cm⁻¹;
a supply unit configured to supply, to the adsorption unit, a metal ion-containing medium to be treated;
a discharge unit configured to discharge the treated medium from the adsorption unit;
a measurement unit that is provided on at least one of a supply side or a discharge side of the adsorption unit and configured to measure the content of metal ions in the medium; and
a control unit that is configured to reduce the amount of the medium supply from the supply unit to the adsorption unit when a value determined based on information from the measurement unit reaches a predetermined value.

11. The system of claim 10, wherein the ligand has an ethylenediamine structure.

12. The system of claim 10, wherein the adsorbent contains 4 wt % to 30 wt % of the ligand.

13. The system of claim 10, wherein the inorganic porous material is particles and has an average primary particle size of from 30 μm to 400 μm.

14. The system of claim 10, wherein the inorganic porous material has an average pore size of from 3.0 nm to 9.0 nm.

15. The system of claim 10, wherein the inorganic porous material is a silica gel.

16. The system of claim 10, wherein four nitrogen atoms in a pair of the ligands exist in a spherical region with a radius of 2.0 Å to 2.2 Å.
